(19) United States
(12) Patent Application Publication
(10) Pub. No.: US 2016/0039191 A1
(43) Pub. Date: Feb. 11, 2016

(54) METHOD FOR MANUFACTURING COMPOSITE MATERIAL WITH FABRIC GRAIN EFFECT

(71) Applicant: San Fang Chemical Industry Co., Ltd., Kaohsiung City (TW)

(72) Inventors: CHUNG-CHIH FENG, Kaohsiung City (TW); PAI-HSIANG WU, Kaohsiung City (TW); CHIEN-CHIA HUANG, Kaohsiung City (TW); TSUNG-YU TSAI, Kaohsiung City (TW)

(21) Appl. No.: 14/585,006

(22) Filed: Dec. 29, 2014

(30) Foreign Application Priority Data
Aug. 6, 2014 (TW) 103126980

(51) Int. Cl. B32B 37/12; B32B 37/06

(52) U.S. Cl. CPC B32B 37/12; B32B 37/06; B32B 2037/1215; B32B 2375/00; B32B 2367/00

(57) ABSTRACT

A method for manufacturing a composite material with a fabric grain effect includes: providing a layer-built body, wherein the layer-built body at least includes a base layer, an adhesive layer and a coating layer, the base layer has a fabric grain structure, the adhesive layer is disposed on the base layer, and the coating layer is disposed on the adhesive layer; preheating the layer-built body to soften the coating layer and the adhesive layer; and performing an air exhausting step for the layer-built body to enable the coating layer and the adhesive layer attached to the fabric grain structure of the base layer, thereby forming the composite material. By this way, the composite material can have prominent fabric grain effect, soft feel and a peeling strength greater than 2 kg/cm², and can also achieve high physical properties of no separation or fracture under a buckling condition greater than 100000.

### FIELD

The disclosure relates to a method for manufacturing a composite material, more particular to a method for manufacturing a composite material with a fabric grain effect.

### BACKGROUND

Conventional mesh or woven fabric materials are generally not waterproof, antifouling, or wear-resisting. To solve the foregoing problems, in the prior art, a processing method of adding a waterproof and moisture permeable film on the back of the mesh or woven fabric is provided; however, this method can only achieve a waterproof effect, but cannot achieve an antifouling or a wear-resisting effect. Therefore, in the prior art, a method of adhering a protection thin film to the surface of the mesh or woven fabric by means of flat-pressing or rolling is also provided; however, despite the fact that this method can improve the waterproof, antifouling, and wear-resisting performance, the grain effect on the surface of the processed mesh or woven fabric is undesirable because the thin film is processed in a flat-pressing or rolling manner, and moreover, problems that the surface feels hard and the thickness is reduced are easily caused.

Therefore, it is necessary to provide a method for manufacturing a composite material with a fabric grain effect, so as to solve the foregoing problems.

### SUMMARY OF THE INVENTION

In accordance with one aspect of the present disclosure, a method for manufacturing a composite material with a fabric grain effect includes step in which a layer-built body is provided, wherein the layer-built body at least includes a base layer, an adhesive layer and a coating layer, the base layer has a fabric grain structure, the adhesive layer is disposed on the base layer, and the coating layer is disposed on the adhesive layer. The method continues with step in which the layer-built body is preheated to soften the coating layer and the adhesive layer. The method continues with step in which an air exhausting step for the layer-built body is performed to enable the coating layer and the adhesive layer attached to the fabric grain structure of the base layer, thereby forming the composite material.

In accordance with another aspect of the present disclosure, a method for manufacturing a composite material with a fabric grain effect includes step in which a layer-built body is provided, wherein the layer-built body includes a base layer, an adhesive layer and a thin film layer, the base layer has a fabric grain structure, the adhesive layer is disposed on the base layer, and the thin film layer is disposed on the adhesive layer. The method continues with step in which the layer-built body is preheated to soften the thin film layer and the adhesive layer. The method continues with step in which an air exhausting step for the layer-built body is performed to enable the thin film layer and the adhesive layer attached to the fabric grain structure of the base layer, thereby forming the composite material.

In the present disclosure, a coating layer or thin film layer is attached to a fabric grain structure of a base layer by means of air extraction that forms a negative pressure. By this way, a composite material that has prominent fabric grain effect and feels soft can be manufactured.

### BRIEF DESCRIPTION OF THE DRAWINGS

Aspects of the present disclosure are understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 shows a flow diagram of a method for manufacturing a composite material with a fabric grain effect according to a first embodiment of the present disclosure.

FIGS. 2A to 2D show schematic diagrams of a method for manufacturing a composite material with a fabric grain effect according to a first embodiment of the present disclosure.

FIG. 3 shows a flow diagram of a method for manufacturing a composite material with a fabric grain effect according to a second embodiment of the present disclosure.

FIGS. 4A to 4D show schematic diagrams of a method for manufacturing a composite material with a fabric grain effect according to a second embodiment of the present disclosure.

FIG. 5 shows a top view of optical microscope observation on a composite material manufactured using the method according to the second embodiment of the present disclosure.

FIG. 6 shows a side view of optical microscope observation on a composite material manufactured using the method according to the second embodiment of the present disclosure.

FIG. 7 shows a comparison view of optical microscope observation between a composite material manufactured under a negative pressure according to the present disclosure (a) and a composite material manufactured by means of flat-pressing in the prior art (b).

### DETAILED DESCRIPTION OF THE INVENTION

It is to be understood that the following disclosure provides many different embodiments or examples, for implementing different features of various embodiments. Specific examples of components and arrangements are described below to simplify the present disclosure. The present disclosure may, however, be embodied in many different forms and should not be construed as being limited to the embodiments set forth herein; rather, these embodiments are provided so that this description will be thorough and complete, and will fully convey the present disclosure to those of ordinary skill in the art. It will be apparent, however, that one or more embodiments may be practiced without these specific details.

In addition, the present disclosure may repeat reference numerals and/or letters in the various examples. This repetition is for the purpose of simplicity and clarity and does not in itself dictate a relationship between the various embodiments and/or configurations discussed.

It will be understood that singular forms “a”, “an” and “the” are intended to include the plural forms as well, unless the context clearly indicates otherwise.

Unless otherwise defined, all terms (including technical and scientific terms) used herein have the same meaning as commonly understood by one of ordinary skill in the art to which this invention belongs. It will be further understood that terms; such as those defined in commonly used dictionaries, should be interpreted as having a meaning that is consistent with their meaning in the context of the relevant art and the present disclosure, and will not be interpreted in an idealized or overly formal sense unless expressly so defined herein.

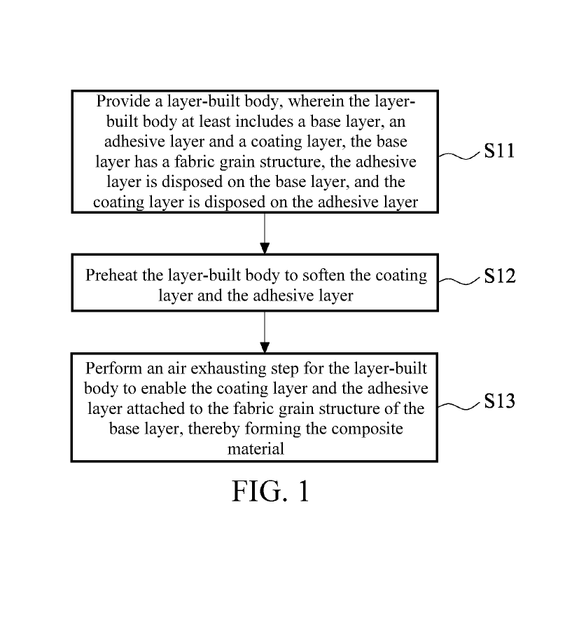

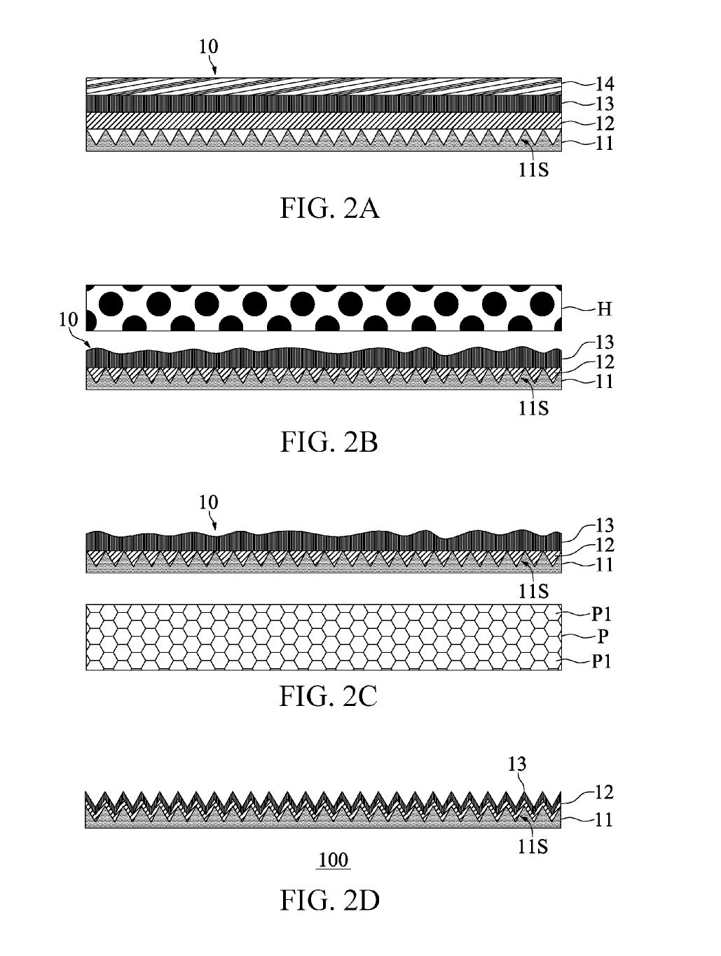

FIG. 1 shows a flow diagram of a method for manufacturing a composite material with a fabric grain effect according to a first embodiment of the present disclosure. FIGS. 2A to 2D show schematic diagrams of a method for manufacturing a composite material with a fabric grain effect according to a first embodiment of the present disclosure.

With reference to Step S11 in FIG. 1 and FIG. 2A, a layer-built body 10 is provided, wherein the layer-built body 10 at least includes a base layer 11, an adhesive layer 12 and a coating layer 13. The base layer 11 has a fabric grain structure 11S. The adhesive layer 12 is disposed on the base layer 11. The coating layer 13 is disposed on the adhesive layer 12. In some embodiments, the layer-built body 10 further includes a release liner layer 14 (FAVINI® ASTRAKAN™). The coating layer 13 is first formed on the release liner layer 14, and then disposed on the adhesive layer 12.

In this step, the base layer 11 is a breathable material, which is made of Ting Sho sandwich air mesh. The adhesive layer 12 is a hot melt adhesive (SANFANG 70 series).

Furthermore, a film forming material of the coating layer 13 is single-dose polyurethane resin (U-BEST POLYMER INDUYSTRY CO., LTD®, AT-508E™). The pigment of the coating layer 13 is selected from TAH KONG CHEMICAL INDUSTRIAL CORP.41P series. Moreover, the coating layer 13 is disposed on the adhesive layer 12 in one of the following manners: spraying, printing, transfer printing, coating, and suspended coating.

With reference to Step S12 in FIG. 1, FIG. 2A, and FIG. 2B, the layer-built body 10 is preheated to soften the coating layer 13 and the adhesive layer 12. In some embodiments, before the layer-built body 10 is preheated, the method can further include a step of removing the release liner layer 14 (FAVINI® ASTRAKAN™).

In this step, a heating softener H is used to preheat the layer-built body 10, and preferably, the preheating temperature is greater than or equal to the softening temperature of the coating layer 13 and the adhesive layer 12.

With reference to Step S13 in FIG. 1, FIG. 2C and FIG. 2D, an air extraction step for the layer-built body 10 is performed to enable the coating layer 13 and the adhesive layer 12 attached to the fabric grain structure 11S of the base layer 11, thereby forming a composite material 100 with a fabric grain effect. In some embodiments, the air extraction step includes extracting air from under the base layer 11 by using a wheel tool or a flat plate P, to form a negative pressure, so that the coating layer 13 and the adhesive layer 12 are tightly attached to the fabric grain structure 11S of the base layer 11. Alternatively, in another embodiment, the wheel tool or the flat plate P can extract air from above the coating layer 13 to form a negative pressure.

Preferably, the air extraction step includes extracting air until vacuum is formed, so as to enhance the attaching strength between the coating layer 13 and the fabric grain structure 11S, and between the adhesive layer 12 and the fabric grain structure 115, thereby enhancing the fabric grain effect.

In some embodiments, the wheel tool or the flat plate P has a breathable structure P1, and the wheel tool or the flat plate P is made of one selected from aluminum and alloy. Alternatively, in another embodiment, the wheel tool or the flat plate P can be directly made of breathable ceramic so that the breathable structure can be omitted.

Finally, after Step S13, a cooling and setting step is performed on the composite material 100, to complete the manufacturing of a finished product.

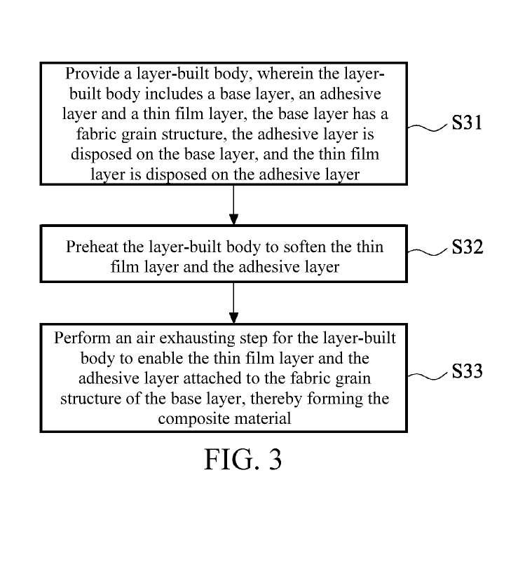

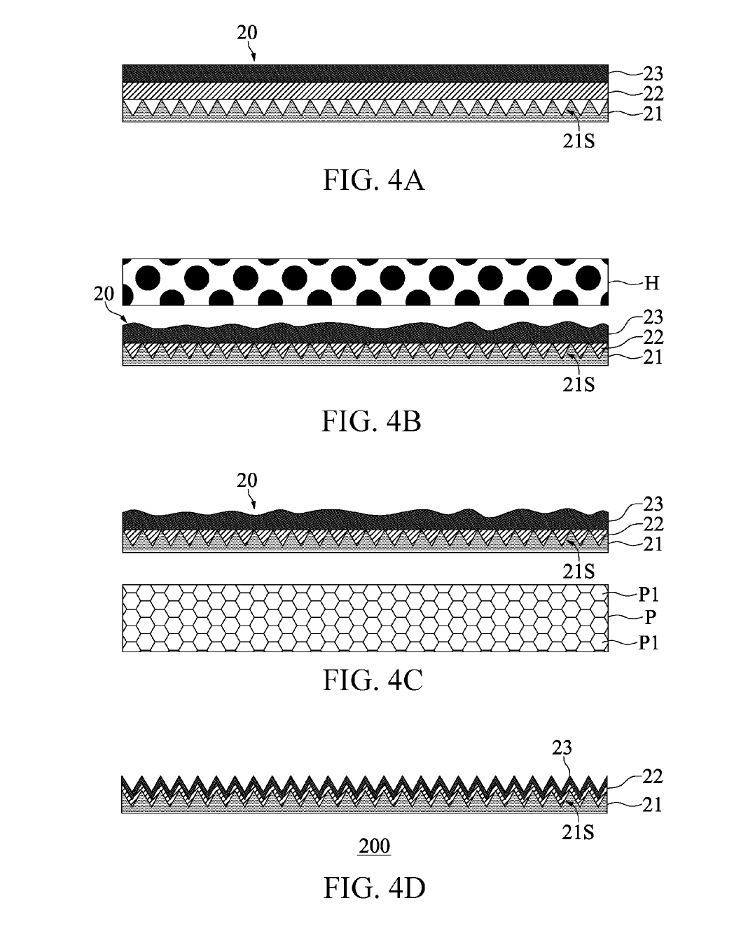

FIG. 3 shows a flow diagram of a method for manufacturing a composite material with a fabric grain effect according to a second embodiment of the present disclosure. FIGS. 4A to 4D show schematic diagrams of a method for manufacturing a composite material with a fabric grain effect according to a second embodiment of the present disclosure.

With reference to Step S31 in FIG. 3 and FIG. 4A, a layer-built body 20 is provided, wherein the layer-built body 20 includes a base layer 21, an adhesive layer 22 and a thin film layer 23. The base layer 21 has a fabric grain structure 21S. The adhesive layer 22 is disposed on the base layer 21. The thin film layer 23 is disposed on the adhesive layer 22.

In this step, the base layer 21 is a breathable material, which is made of Ting Sho sandwich air mesh. The adhesive layer 22 is a hot melt adhesive (SANFANG 70 series).

In addition, the material of the thin film layer 23 is a thermosetting or thermoplastic material such as polyurethane (PU) resin, polycarbonate (PC) resin, polyethylene (PE) resin, polypropylene (PP) resin, and polyethylene terephthalate (PET) resin. Preferably, the material of the thin film layer 23 is single-dose polyurethane resin (U-BEST POLYMER INDUYSTRY CO., LTD®, AT-508E™).

With reference to Step S32 in FIG. 3 and FIG. 4B, the layer-built body 20 is preheated to soften the thin film layer 23 and the adhesive layer 22. In this step, a heating softener H is used to preheat the layer-built body 20, and preferably, the preheating temperature is greater than or equal to the softening temperature of the thin film layer 23 and the adhesive layer 22.

With reference to Step S33 in FIG. 3, FIG. 4C, and FIG. 4D, an air extraction step for the layer-built body 20 is performed to enable the thin film layer 23 and the adhesive layer 22 attached to the fabric grain structure 21S of the base layer 21, thereby forming a composite material 200 with a fabric grain effect. In some embodiments, the air extraction step includes extracting air from under the base layer 21 by using a wheel tool or a flat plate P, to form a negative pressure, so that the thin film layer 23 and the adhesive layer 22 are tightly attached to the fabric grain structure 21S of the base layer 21. Alternatively, in another embodiment, the wheel tool or the flat plate P can extract air from above the thin film layer 23 to form a negative pressure.

Preferably, the air extraction step includes extracting air until vacuum is formed, so as to enhance the attaching strength between the thin film layer 23 and the fabric grain structure 21S, and between the adhesive layer 22 and the fabric grain structure 21S, thereby enhancing the fabric grain effect.

In some embodiments, the wheel tool or the flat plate P is made of one selected from aluminum and alloy. Alternatively, in another embodiment, the wheel tool or the flat plate P can be directly made of breathable ceramic so that the breathable structure can be omitted.

Finally, after Step S33, a cooling and setting step is performed on the composite material 200, to complete the manufacturing of a finished product.

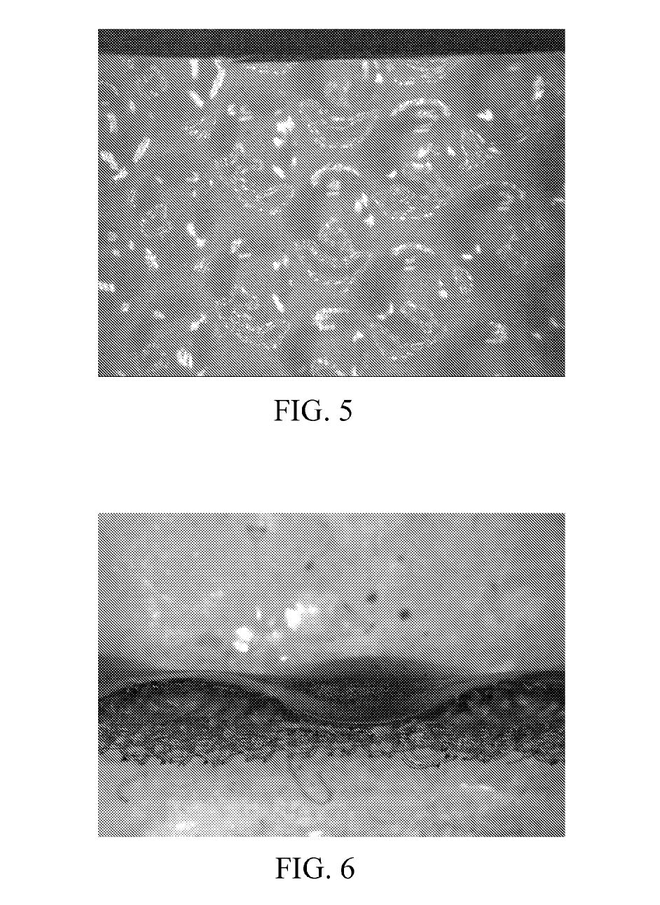

FIG. 5 shows a top view of optical microscope observation on a composite material manufactured using the method according to the second embodiment of the present disclosure. FIG. 6 shows a side view of optical microscope observation on a composite material manufactured using the method according to the second embodiment of the present disclosure.

With preference to FIG. 5 and FIG. 6, the observation result shows that the composite material manufactured according to the present disclosure indeed has an obvious fabric grain effect.

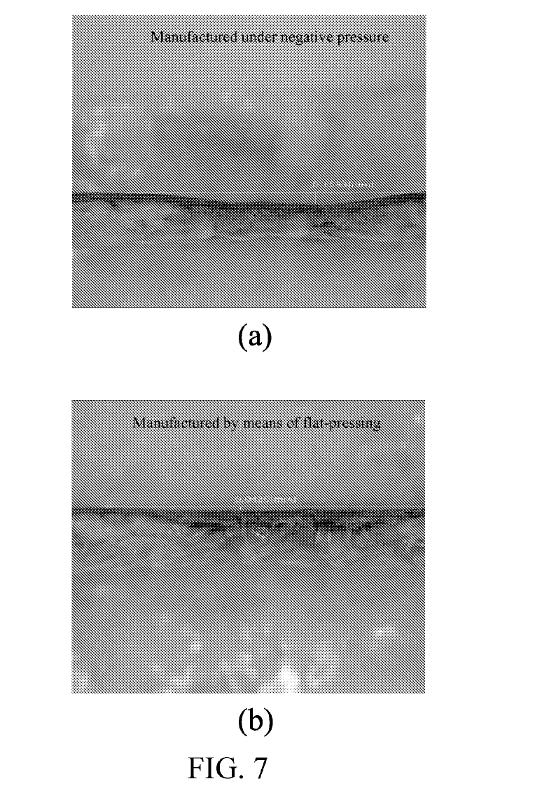

Referring to FIG. 7, which shows a comparison view of optical microscope observation between a composite material manufactured under a negative pressure according to the present disclosure (a) and a composite material manufactured by means of flat-pressing in the prior art (b). As shown in FIG. 7, a grain depth of the composite material manufactured under a negative pressure according to the present disclosure is 3.6 times that of the composite material manufactured by means of flat-pressing in the prior art, indicating that the method of the present disclosure can improve the fabric grain effect by multiple times.

In the present disclosure, a coating layer or thin film layer is attached to a fabric grain structure of a base layer by means of air extraction that forms a negative pressure. In this manner, a waterproof, antifouling, and wear-resisting composite material that has an obvious fabric grain effect and feels soft can be manufactured.

Furthermore, the method of the present disclosure rarely affects the stiffness and thickness of the composite material, and therefore, air can flow in the base layer, thereby having a lateral breathing effect.

Moreover, when applied to shoes, the composite material manufactured according to the present disclosure can have a peel strength greater than 2 kg/cm² (referring to standards DIN-53357-A and DIN-53273), and can also achieve high physical properties of no separation or fracture (referring to standard DIN-5335) under a buckling condition greater than 100000; and with the adjustment of types of the coating layer, the adhesive layer and the base layer, the peel strength and buckling resistance can also be adjusted as required.

Moreover, the scope of the present application is not intended to be limited to the particular embodiments of the process, machine, manufacture, and composition of matter, means, methods and steps described in the specification. As those skilled in the art will readily appreciate form the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure.

Accordingly, the appended claims are intended to include within their scope such processes, machines, manufacture, and compositions of matter, means, methods or steps. In addition, each claim constitutes a separate embodiment, and the combination of various claims and embodiments are within the scope of the invention.

What is claimed is:

1. A method for manufacturing a composite material with a fabric grain effect, comprising:
(a) providing a layer-built body, wherein the layer-built body at least includes a base layer, an adhesive layer and a coating layer, the base layer has a fabric grain structure, the adhesive layer is disposed on the base layer, and the coating layer is disposed on the adhesive layer;
(b) preheating the layer-built body to soften the coating layer and the adhesive layer; and
(c) performing an air exhausting step for the layer-built body to enable the coating layer and the adhesive layer attached to the fabric grain structure of the base layer, thereby forming the composite material.

2. The method of claim 1, wherein the base layer of the step (a) is a breathable material.

3. The method of claim 1, wherein the adhesive layer of the step (a) is a hot melt adhesive.

4. The method of claim 1, wherein the preheating temperature of the step (b) is greater than or equal to the softening temperature of the coating layer and the adhesive layer.

5. The method of claim 1, wherein the air extraction step of the step (c) includes extracting air by using a wheel tool or a flat plate, to form a negative pressure.

6. A method for manufacturing a composite material with a fabric grain effect, comprising:
(a) providing a layer-built body, wherein the layer-built body includes a base layer, an adhesive layer and a thin film layer, the base layer has a fabric grain structure, the adhesive layer is disposed on the base layer, and the thin film layer is disposed on the adhesive layer;
(b) preheating the layer-built body to soften the thin film layer and the adhesive layer; and
(c) performing an air exhausting step for the layer-built body to enable the thin film layer and the adhesive layer attached to the fabric grain structure of the base layer, thereby forming the composite material.

7. The method of claim 6, wherein the base layer of the step (a) is a breathable material.

8. The method of claim 6, wherein the adhesive layer of the step (a) is a hot melt adhesive.

9. The method of claim 6, wherein the material of the thin film layer is a thermosetting or thermoplastic material such as polyurethane (PU) resin, polycarbonate (PC) resin, polyethylene (PE) resin, polypropylene (PP) resin, and polyethylene terephthalate (PET) resin.

10. The method of claim 6, wherein the preheating temperature of the step (b) is greater than or equal to the softening temperature of the thin film layer and the adhesive layer.

11. The method of claim 6, wherein the air extraction step of the step (c) includes extracting air by using a wheel tool or a flat plate, to form a negative pressure.
